(19) United States
(12) Patent Application Publication
(10) Pub. No.: US 2026/0012778 A1
(43) Pub. Date: Jan. 8, 2026

(54) METHOD AND APPARATUS FOR COLLECTING LEARNING DATA OF INTELLIGENCE MODELS

(71) Applicant: ELECTRONICS AND TELECOMMUNICATIONS RESEARCH INSTITUTE, Daejeon (KR)

(72) Inventor: Tae Chul HONG, Daejeon (KR)

(73) Assignee: ELECTRONICS AND TELECOMMUNICATIONS RESEARCH INSTITUTE, Daejeon (KR)

(21) Appl. No.: 19/255,190

(22) Filed: Jun. 30, 2025

(30) Foreign Application Priority Data
Jul. 8, 2024 (KR) 10-2024-0089620

(51) Int. Cl. H04W 8/24; G06N 20/00; H04W 76/30

(52) U.S. Cl. CPC H04W 8/24; G06N 20/00; H04W 76/30

(57) ABSTRACT

A method of a terminal may comprise: transmitting, to a base station, at least one of Artificial Intelligence/Machine Learning (AI/ML) information of the terminal or data storage information which is a data storage capability of the terminal; receiving data storage configuration information generated by the base station based on the data storage information; storing collected data for event(s) included in the data storage configuration information; and transmitting and receiving the collected data with the base station.

### CROSS-REFERENCE TO RELATED APPLICATIONS

This application claims priority to Korean Patent Application No. 10-2024-0089620, filed on Jul. 8, 2024, with the Korean Intellectual Property Office (KIPO), the entire contents of which are hereby incorporated by reference.

### BACKGROUND

### 1. Technical Field

The present disclosure relates to a technique of collecting training data for artificial intelligence (AI) models, and more particularly, to a method of collecting data required for performing AI model retraining in a communication system.

### 2. Related Art

Artificial intelligence/machine learning (AI/ML) technologies may be utilized in various fields. In particular, the AI/ML technologies may be applied to various fields of a mobile communication system (e.g. a core network, radio interfaces, and the like). In the case of an AI model for applying AI/ML technology to an actual mobile communication environment, the performance of the AI model may degrade over time after being deployed to users. The performance of the AI model may degrade over time after being deployed due to various factors such as environmental changes or system information changes. To maintain service quality of the AI model, it may be necessary to monitor performance degradation of the AI model. To maintain service quality of the AI model, a system for updating the AI model may be needed.

Various methods may exist to monitor an AI model and detect performance degradation. When performance degradation of the AI model is detected through the method of monitoring the AI model, the AI model may be retrained. The retrained AI model may be re-deployed. When utilizing AI/ML technologies, performance degradation of the AI model needs to be detected. When utilizing AI/ML technologies, the AI model may require retraining data to maintain its performance. The retraining data may include data from cases where the performance of the AI model is degraded and the AI model does not operate properly. In other words, there may be a problem that data causing performance degradation of the AI model is included in the retraining data. In order to prevent data causing performance degradation of the AI model from being included in the retraining data, a labeled dataset for a changed state and the like may be needed. When high-quality retraining data is not secured, even if the AI model is retrained, it may be difficult to maintain its performance.

### SUMMARY

The present disclosure for resolving the above-described problems is directed to providing a method and apparatus of collecting training data for AI models.

According to a first exemplary embodiment of the present disclosure, a method of a terminal may comprise: transmitting, to a base station, at least one of Artificial Intelligence/Machine Learning (AI/ML) information of the terminal or data storage information which is a data storage capability of the terminal; receiving data storage configuration information generated by the base station based on the data storage information; storing collected data for event(s) included in the data storage configuration information; and transmitting and receiving the collected data with the base station.

The transmitting and receiving of the collected data may comprise: transmitting a connection release request to the base station; in response to the connection release request, receiving a collected data request from the base station; and transmitting and receiving the collected data with the base station.

The transmitting and receiving of the collected data may comprise: identifying an idle state of the terminal; transmitting collected data transmission notification information to the base station in the idle state; receiving collected data transmission confirmation information from the base station; and transmitting and receiving the collected data with the base station based on the collected data transmission confirmation information.

The method may further comprise: combining the collected data to generate training data; and retraining an AI model included in the terminal using the training data.

The transmitting of the at least one of the AI/ML information or the data storage information may comprise: transmitting, to the base station, a message including at least one of: AI/ML functionality identifier(s) for AI/ML functionalities included in the AI/ML information of the terminal, AI/ML model information identifier(s) for AI/ML model(s) included in the AI/ML information, or a data storage information identifier for the data storage information.

In the transmitting and receiving of the collected data, the collected data may include at least one identifier among a network identifier for the terminal and the base station or a terminal identifier of the terminal.

According to a second exemplary embodiment of the present disclosure, a method of a base station may comprise: receiving, from a terminal, at least one of Artificial Intelligence/Machine Learning (AM/ML) information or data storage information; generating data storage configuration information using at least one of the AI/ML information or the data storage information; transmitting the data storage configuration information to the terminal; storing second collected data for event(s) included in the data storage configuration information; and receiving first collected data collected by the terminal using the data storage configuration information.

The method may further comprise: transmitting the first collected data and the second collected data to a data storage; determining whether a concept drift occurs for an AI/ML model using data in the data storage; and in response to determining that a concept drift occurs, retraining the AI/ML model using the data as training data.

The generating of the data storage configuration information may comprise: determining a priority of the collected data by using storage capacity information of the terminal included in the data storage information; and generating the data storage configuration information according to the priority.

The determining of whether a concept drift occurs for the AI/ML model may comprise: extracting data for each AI/ML functionality or each AI/ML model stored in the data; and determining whether a concept drift occurs for each AI/ML functionality or each AI/ML model based on the extracted data.

The data storage configuration information may include at least one of an event identifier for the terminal to collect data, a collected data identifier that is a type of data collected by the terminal, or a data storage identifier for identifying when storing the collected data.

According to a third exemplary embodiment of the present disclosure, a terminal may comprise at least one processor, and the at least one processor may cause the terminal to perform: transmitting, to a base station, at least one of Artificial Intelligence/Machine Learning (AI/ML) information of the terminal or data storage information which is a data storage capability of the terminal; receiving data storage configuration information generated by the base station based on the data storage information; storing collected data for event(s) included in the data storage configuration information; and transmitting and receiving the collected data with the base station.

In the transmitting and receiving of the collected data, the at least one processor may further cause the terminal to perform: transmitting a connection release request to the base station; in response to the connection release request, receiving a collected data request from the base station; and transmitting and receiving the collected data with the base station.

In the transmitting and receiving of the collected data, the at least one processor may further cause the terminal to perform: identifying an idle state of the terminal; transmitting collected data transmission notification information to the base station in the idle state; receiving collected data transmission confirmation information from the base station; and transmitting and receiving the collected data with the base station based on the collected data transmission confirmation information.

The at least one processor may further cause the terminal to perform: combining the collected data to generate training data; and retraining an AI model included in the terminal using the training data.

In the transmitting of the at least one of the AI/ML information or the data storage information, the at least one processor may further cause the terminal to perform: transmitting, to the base station, a message including at least one of: AI/ML functionality identifier(s) for AI/ML functionalities included in the AI/ML information of the terminal, AI/ML model information identifier(s) for AI/ML model(s) included in the AI/ML information, or a data storage information identifier for the data storage information.

In the transmitting and receiving of the collected data, the collected data may include at least one identifier among a network identifier for the terminal and the base station or a terminal identifier of the terminal.

According to the present disclosure, when a communication system utilizes an AI model, the AI model can continuously maintain its quality by securing training data required for actual communication situations. The AI model can prevent performance degradation by continuously updating the AI model using training data required for actual communication situations. The AI model securing training data required for actual communication situations can establish an operation system capable of continuously managing performance quality of the AI model.

### BRIEF DESCRIPTION OF DRAWINGS

FIG. 1 is a conceptual diagram illustrating an exemplary embodiment of a communication system.

FIG. 2 is a block diagram illustrating an exemplary embodiment of a communication node constituting a communication system.

FIG. 3 is a block diagram illustrating exemplary embodiments of a radio interface including a satellite.

FIG. 4 is a block diagram illustrating exemplary embodiments of a radio interface including a satellite.

FIG. 5 is a block diagram illustrating exemplary embodiments of utilizing an AI model considering a physical (PHY) layer.

FIG. 6 is a block diagram illustrating exemplary embodiments of utilizing an AI model considering higher layers.

FIG. 7 is a block diagram illustrating exemplary embodiments of an AI model operation structure.

FIG. 8 is a block diagram illustrating exemplary embodiments of digital signal processing at a transmitting side.

FIG. 9 is a block diagram illustrating exemplary embodiments of digital signal processing at a receiving side.

FIG. 10 is a block diagram illustrating exemplary embodiments of data transmission between a transmitting side and a receiving side.

FIG. 11 is a conceptual diagram illustrating exemplary embodiments of AI/ML model training.

FIG. 12 is a flowchart illustrating exemplary embodiments of a HARQ retransmission form.

FIG. 13 is a block diagram illustrating exemplary embodiments of an identifier for data storage.

FIG. 14 is a block diagram illustrating exemplary embodiments of AI/ML related information.

FIG. 15 is a block diagram illustrating exemplary embodiments of an AI/ML information provision message.

FIG. 16 is a block diagram illustrating exemplary embodiments of data collection information for multiple events.

FIG. 17 is a sequence chart illustrating exemplary embodiments of transmission of collected data.

FIG. 18 is a sequence chart illustrating exemplary embodiments of transmission of collected data.

FIG. 19 is a flowchart illustrating exemplary embodiments of data storage configuration information.

FIG. 20 is a conceptual diagram illustrating exemplary embodiments of collected data storage.

FIG. 21 is a conceptual diagram illustrating exemplary embodiments of concept drift determination.

### DETAILED DESCRIPTION OF THE EMBODIMENTS

Exemplary embodiments of the present disclosure are disclosed herein. However, specific structural and functional details disclosed herein are merely representative for purposes of describing embodiments of the present disclosure. Thus, embodiments of the present disclosure may be embodied in many alternate forms and should not be construed as limited to embodiments of the present disclosure set forth herein.

Accordingly, while the present disclosure is capable of various modifications and alternative forms, specific embodiments thereof are shown by way of example in the drawings and will herein be described in detail. It should be understood, however, that there is no intent to limit the present disclosure to the particular forms disclosed, but on the contrary, the present disclosure is to cover all modifications, equivalents, and alternatives falling within the spirit and scope of the present disclosure. Like numbers refer to like elements throughout the description of the figures.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present disclosure. As used herein, the term “and/or” includes any and all combinations of one or more of the associated listed items.

In exemplary embodiments of the present disclosure, “at least one of A and B” may mean “at least one of A or B” or “at least one of combinations of one or more of A and B”. Also, in exemplary embodiments of the present disclosure, “one or more of A and B” may mean “one or more of A or B” or “one or more of combinations of one or more of A and B”.

In the present disclosure, (re)transmission may refer to ‘transmission’, ‘retransmission’, or ‘transmission and retransmission’, (re)configuration may refer to ‘configuration’, ‘reconfiguration’, or ‘configuration and reconfiguration’, (re)connection may refer to ‘connection’, ‘reconnection’, or ‘connection and reconnection’, and (re)access may refer to ‘access’, ‘re-access’, or ‘access and re-access’.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (i.e. “between” versus “directly between,” “adjacent” versus “directly adjacent,” etc.).

The terminology used herein is for the purpose of describing particular embodiments only and is not intended to be limiting of the present disclosure. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this present disclosure belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, exemplary embodiments of the present disclosure will be described in greater detail with reference to the accompanying drawings. In order to facilitate general understanding in describing the present disclosure, the same components in the drawings are denoted with the same reference signs, and repeated description thereof will be omitted. In the present disclosure, not only the exemplary embodiments explicitly described, but also operations according to combinations of exemplary embodiments, extensions of exemplary embodiments, and/or variations of exemplary embodiments may be performed. The performance of some operations may be omitted, and the order of performing the operations may be changed.

In exemplary embodiments, even when a method (e.g. transmission or reception of a signal) performed at a first communication node among communication nodes is described, a corresponding second communication node may perform a method (e.g. reception or transmission of the signal) corresponding to the method performed at the first communication node. In other words, when an operation of a user equipment (UE) is described, a corresponding base station may perform an operation corresponding to the operation of the UE. Conversely, when an operation of a base station is described, a corresponding UE may perform an operation corresponding to the operation of the base station. In a non-terrestrial network (NTN) (e.g. a payload-based NTN), an operation of a base station may refer to an operation of a satellite, and an operation of the satellite may refer to an operation of the base station.

A base station may be referred to as a NodeB, evolved NodeB, next generation Node B (gNodeB), gNB, device, apparatus, node, communication node, base transceiver station (BTS), radio remote head (RRH), transmission reception point (TRP), radio unit (RU), road side unit (RSU), radio transceiver, access point, or access node. A UE may be referred to as a terminal, device, apparatus, node, communication node, end node, access terminal, mobile terminal, station, subscriber station, mobile station, portable subscriber station, or on-board unit (OBU).

In the present disclosure, signaling may include at least one of higher layer signaling, MAC signaling, or physical (PHY) signaling. A message used for higher layer signaling may be referred to as a ‘higher layer message’ or ‘higher layer signaling message’. A message used for MAC signaling may be referred to as a ‘MAC message’ or ‘MAC signaling message’. A message used for PHY signaling may be referred to as a ‘PHY message’ or ‘PHY signaling message’. Higher layer signaling may refer to transmission and reception operations of system information (e.g. a master information block (MIB), a system information block (SIB)) and/or an RRC message. MAC signaling may refer to transmission and reception operations of a MAC control element (MAC CE). PHY signaling may refer to transmission and reception operations of control information (e.g. downlink control information (DCI), uplink control information (UCI), or sidelink control information (SCI)).

In the present disclosure, ‘an operation (e.g. transmission operation) being configured’ may refer to signaling of ‘configuration information (e.g. information element(s) or parameter(s)) for the corresponding operation’ and/or ‘information indicating execution of the corresponding operation’. ‘An information element (e.g. parameter) being configured’ may refer to the corresponding information element being signaled. In the present disclosure, ‘signal and/or channel’ may refer to a signal, a channel, or ‘both a signal and a channel’, and the term signal may be used in the sense of ‘signal and/or channel’.

A communication system may include at least one of a terrestrial network, a non-terrestrial network, a 4G communication network (e.g. long-term evolution (LTE) communication network), a 5G communication network (e.g. new radio (NR) communication network), or a 6G communication network. Each of the 4G communication network, the 5G communication network, and the 6G communication network may include a terrestrial network and/or a non-terrestrial network. A non-terrestrial network may operate based on at least one communication technology among LTE communication technology, 5G communication technology, or 6G communication technology. A non-terrestrial network may provide communication services in various frequency bands.

A communication network to which exemplary embodiments are applied is not limited to the descriptions provided below, and the exemplary embodiments may be applied to various communication networks (e.g. 4G communication network, 5G communication network, and/or 6G communication network). Herein, the term communication network may be used in the same sense as the communication system.

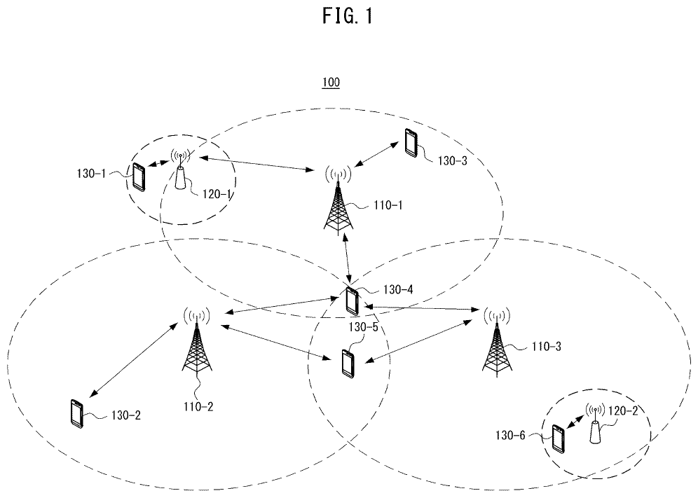

FIG. 1 is a conceptual diagram illustrating an exemplary embodiment of a communication system.

Referring to FIG. 1, a communication system 100 may comprise a plurality of communication nodes 110-1, 110-2, 110-3, 120-1, 120-2, 130-1, 130-2, 130-3, 130-4, 130-5, and 130-6. The plurality of communication nodes may support 4G communication (e.g. long term evolution (LTE), LTE-advanced (LTE-A)), 5G communication (e.g. new radio (NR)), 6G communication, etc. specified in the 3rd generation partnership project (3GPP) standards. The 4G communication may be performed in frequency bands below 6 GHz, and the 5G and 6G communication may be performed in frequency bands above 6 GHz as well as frequency bands below 6 GHz.

For example, in order to perform the 4G communication, 5G communication, and 6G communication, the plurality of communication nodes may support a code division multiple access (CDMA) based communication protocol, wideband CDMA (WCDMA) based communication protocol, time division multiple access (TDMA) based communication protocol, frequency division multiple access (FDMA) based communication protocol, orthogonal frequency division multiplexing (OFDM) based communication protocol, filtered OFDM based communication protocol, cyclic prefix OFDM (CP-OFDM) based communication protocol, discrete Fourier transform spread OFDM (DFT-s-OFDM) based communication protocol, orthogonal frequency division multiple access (OFDMA) based communication protocol, single carrier FDMA (SC-FDMA) based communication protocol, non-orthogonal multiple access (NOMA) based communication protocol, generalized frequency division multiplexing (GFDM) based communication protocol, filter bank multi-carrier (FBMC) based communication protocol, universal filtered multi-carrier (UFMC) based communication protocol, space division multiple access (SDMA) based communication protocol, or the like.

Further, the communication system 100 may further include a core network. When the communication system 100 supports 4G communication, the core network may include a serving gateway (S-GW), packet data network (PDN) gateway (P-GW), mobility management entity (MME), and the like. When the communication system 100 supports 5G communication or 6G communication, the core network may include a user plane function (UPF), session management function (SMF), access and mobility management function (AMF), and the like.

Meanwhile, each of the plurality of communication nodes 110-1, 110-2, 110-3, 120-1, 120-2, 130-1, 130-2, 130-3, 130-4, 130-5, and 130-6 constituting the communication system 100 may have the following structure.

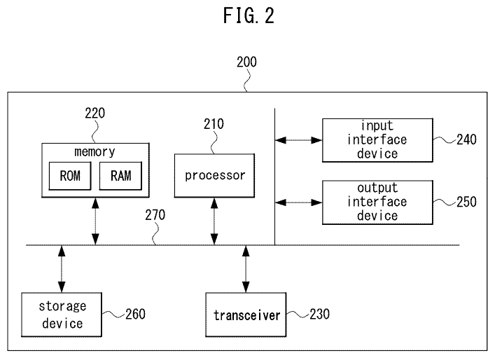

FIG. 2 is a block diagram illustrating an exemplary embodiment of a communication node constituting a communication system.

Referring to FIG. 2, a communication node 200 may comprise at least one processor 210, a memory 220, and a transceiver 230 connected to the network for performing communications. Also, the communication node 200 may further comprise an input interface device 240, an output interface device 250, a storage device 260, and the like. Each component included in the communication node 200 may communicate with each other as connected through a bus 270.

However, each component included in the communication node 200 may not be connected to the common bus 270 but may be connected to the processor 210 via an individual interface or a separate bus. For example, the processor 210 may be connected to at least one of the memory 220, the transceiver 230, the input interface device 240, the output interface device 250 and the storage device 260 via a dedicated interface.

The processor 210 may execute a program stored in at least one of the memory 220 and the storage device 260. The processor 210 may refer to a central processing unit (CPU), a graphics processing unit (GPU), or a dedicated processor on which methods in accordance with embodiments of the present disclosure are performed. Each of the memory 220 and the storage device 260 may be constituted by at least one of a volatile storage medium and a non-volatile storage medium. For example, the memory 220 may comprise at least one of read-only memory (ROM) and random access memory (RAM).

Referring again to FIG. 1, the communication system 100 may comprise a plurality of base stations 110-1, 110-2, 110-3, 120-1, and 120-2, and a plurality of terminals 130-1, 130-2, 130-3, 130-4, 130-5, and 130-6. The communication system 100 including the base stations 110-1, 110-2, 110-3, 120-1, and 120-2 and the terminals 130-1, 130-2, 130-3, 130-4, 130-5, and 130-6 may be referred to as an ‘access network’. Each of the first base station 110-1, the second base station 110-2, and the third base station 110-3 may form a macro cell, and each of the fourth base station 120-1 and the fifth base station 120-2 may form a small cell. The fourth base station 120-1, the third terminal 130-3, and the fourth terminal 130-4 may belong to cell coverage of the first base station 110-1. In addition, the second terminal 130-2, the fourth terminal 130-4, and the fifth terminal 130-5 may belong to cell coverage of the second base station 110-2. In addition, the fifth base station 120-2, the fourth terminal 130-4, the fifth terminal 130-5, and the sixth terminal 130-6 may belong to cell coverage of the third base station 110-3. In addition, the first terminal 130-1 may belong to cell coverage of the fourth base station 120-1, and the sixth terminal 130-6 may belong to cell coverage of the fifth base station 120-2.

Here, each of the plurality of base stations 110-1, 110-2, 110-3, 120-1, and 120-2 may refer to a Node-B (NB), evolved Node-B (eNB), base transceiver station (BTS), radio base station, radio transceiver, access point, access node, road side unit (RSU), radio remote head (RRH), transmission point (TP), transmission and reception point (TRP), eNB, gNB, or the like.

Each of the plurality of terminals 130-1, 130-2, 130-3, 130-4, 130-5, and 130-6 may refer to a user equipment (UE), terminal, access terminal, mobile terminal, station, subscriber station, mobile station, portable subscriber station, node, device, Internet of Thing (IoT) device, mounted module/device/terminal, on-board device/terminal, or the like.

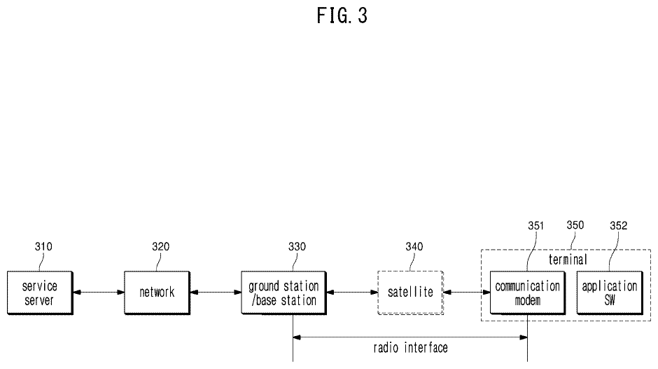

FIG. 3 is a block diagram illustrating exemplary embodiments of a radio interface including a satellite.

Referring to FIG. 3, a service server 310 may transmit and receive data with a network 320. The network 320 may transmit and receive data with a ground station/base station 330. The ground station/base station 330 may transmit and receive data with a satellite 340. The satellite 340 may transmit and receive data with a terminal 350. In other words, the satellite 340 may transmit and receive data with a communication modem 351 of the terminal. The terminal 350 may include at least one of the communication modem 351 and an application software (SW) 352. A section between the communication modem 351 of the terminal and the ground station/base station 330 may be referred to as a radio interface section.

In a mobile communication system, a radio interface section may refer to a section wirelessly connected between a base station and a terminal. In a non-terrestrial network (NTN), the radio interface section may be defined differently depending on a role of the satellite. The satellite 340 may perform a signal relay function. When the satellite performs the signal relay function, a section between the terminal 350 and the ground station/base station 330 may be defined as a radio interface section.

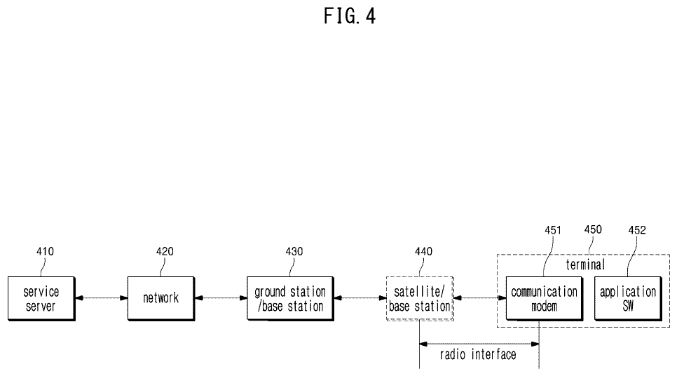

FIG. 4 is a block diagram illustrating exemplary embodiments of a radio interface including a satellite.

Referring to FIG. 4, a service server 410 may transmit and receive data with a network 420. The network 420 may transmit and receive data with a ground station/base station 430. The ground station/base station 430 may transmit and receive data with a satellite/base station 440. The satellite/base station 440 may transmit and receive data with a terminal 450. In other words, the satellite/base station 440 may transmit and receive data with a communication modem 451 of the terminal. The terminal 450 may include at least one of the communication modem 451 and an application SW 452. A section between the communication modem 451 of the terminal and the satellite/base station 440 may be referred to as a radio interface section.

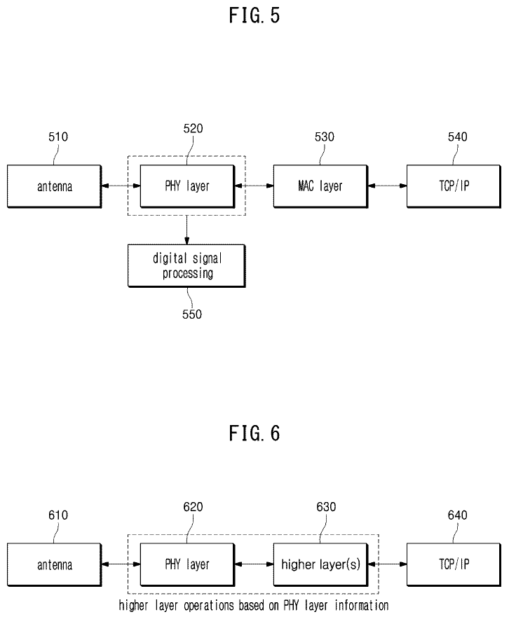

The satellite 440 may perform functions of a base station. When the satellite 440 performs functions of a base station, a section between the terminal 450 and the satellite 440 may be defined as a radio interface section. An artificial intelligence (AI) model may be utilized in the radio interface section. When an AI model is utilized in the radio interface section, a PHY layer may be considered. A method of utilizing the AI model considering the PHY layer may be as shown in FIG. 5.

FIG. 5 is a block diagram illustrating exemplary embodiments of utilizing an AI model considering a physical (PHY) layer.

Referring to FIG. 5, an antenna 510 may transmit and receive data with a PHY layer 520. The PHY layer 520 may transmit and receive data with a media access control (MAC) layer 530. The PHY layer 520 may perform a digital signal processing function 550 using received data. The MAC layer 530 may transmit and receive data with a transmission control protocol/internet protocol (TCP/IP) 540.

When an AI model is utilized in the radio interface section, higher layer(s) may be considered. A method of utilizing the AI model considering the higher layer(s) may be as shown in FIG. 6.

FIG. 6 is a block diagram illustrating exemplary embodiments of utilizing an AI model considering higher layers.

Referring to FIG. 6, an antenna 610 may transmit and receive data with a PHY layer 620. The PHY layer 620 may transmit and receive data with higher layer(s) 630. The higher layer(s) may operate based on information of the PHY layer. AI model(s) may be utilized for functions of the higher layer(s) that operate based on the information of the PHY layer. The higher layer(s) 630 may transmit and receive data with a TCP/IP 640.

A supervised learning-based AI model may be utilized in the radio interface. To utilize the AI model, the AI model may be trained and/or learned through various data. The data for training the AI model may include measured data. The data for training the AI model may include data generated through a simulation environment.

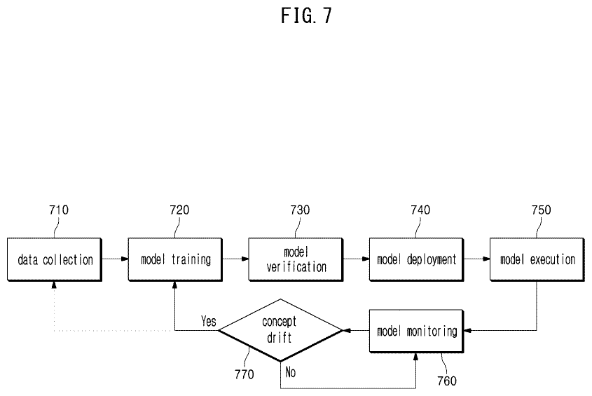

The performance of the supervised learning-based AI model may be affected by a quality of the training data. For the performance of the supervised learning-based AI model, diverse data from actual environments may be required as training data. The AI model trained to a level suitable for an actual environment may be deployed and utilized. When the AI model is applied to an actual environment, it may be difficult to determine whether the AI model operates properly. In other words, whether an inference result of the AI model is accurate may be difficult to determine in real time. For example, when using a CCTV applying a Convolutional Neural Network (CNN) model for detecting a person, whether the CNN model has detected a person may be determined because a person does not judge a result of the model inference in real time. A final judgment as to whether an object detected by the AI model is a person may be made directly by a person. Various methods may be used to monitor and determine a performance degradation of the AI model without a person's judgment. When the performance degradation of the AI model is determined, the AI model may be retrained. The retrained AI model may be redeployed. A method of retraining and redeploying the AI model having performance degradation may be as shown in FIG. 7.

FIG. 7 is a block diagram illustrating exemplary embodiments of an AI model operation structure.

Referring to FIG. 7, an initial stage of utilizing the AI model may be focused on development of the AI model. Then, a method of operating the deployed AI model may become important. The method of operating the AI model may include at least one of a method of monitoring a performance of the AI model, a method of retraining the AI model, or a method of redeploying the retrained AI model. An operation structure for the method of operating the AI model may be as follows.

The method/structure of operating the AI model may include at least one stage among a data collection stage 710, a model training stage 720, a model verification stage 730, a model deployment stage 740, a model execution stage 750, a model monitoring stage 760, or a concept drift stage 770.

The data collection stage 710 may refer to a stage of collecting or storing data regarding events generated by the terminal or the base station. The model training stage 720 may refer to a stage of training the AI model included in the terminal or the base station using the collected data. The model verification stage 730 may refer to a stage of determining whether the AI model operates normally. The model deployment stage 740 may refer to a stage of transferring the trained AI model to another terminal or base station by the base station or the terminal. The model execution stage 750 may refer to a stage of performing functionalities using the AI model by the terminal or the base station. The model monitoring stage 760 may refer to a stage of monitoring the AI model to determine whether the AI model operates normally by the terminal or the base station. The concept drift stage 770 may refer to a stage of determining whether a concept drift occurs in the AI model.

The method of operating the AI model may be applied to a communication system utilizing the AI model. In the case of the AI model utilized in the radio interface of the communication system, the method of operating the AI model may perform performance monitoring of the AI model. The method of operating the AI model may include a method of determining a performance degradation of the AI model. The performance degradation of the AI model may be referred to as a concept drift. The method of operating the AI model may include a method of retraining the AI model. The method of operating the AI model may include a method of redeploying the retrained AI model.

The concept drift stage 770 may refer to a stage of determining whether the performance of the AI model has degraded. When the performance degradation of the AI model occurs, in other words, when a concept drift occurs, the base station or the terminal may collect data required for the AI model at a time when the concept drift occurs. In a case where continuous data collection is required in an environment in which an inference result of the AI model is inaccurate, in addition to the performance degradation (concept drift), the base station or the terminal may collect data required for the AI model. Collecting data required for the AI model at the time when the concept drift occurs may make it difficult to quickly respond to a degradation of communication quality.

The AI model may be retrained to address the performance degradation. When the AI model is retrained, the performance of the AI model may be improved by using training data that contains a large amount of data related to the environment in which the performance of the AI model is degraded.

When developing the AI model, collecting performance-critical data may be more difficult than collecting environmental data. For example, to train an AI model that diagnoses machine faults, data from before and after faults occur may be important. Measured data of this type may be scarce. When measured data is obtained by intentionally causing a fault, it may differ from real-world data. Data for retraining the AI model for the communication system may not be stored. The base station or the terminal may store only data related to situations or environments of high importance. By storing only data related to situations or environments of high importance, the burden on communication system components may be reduced.

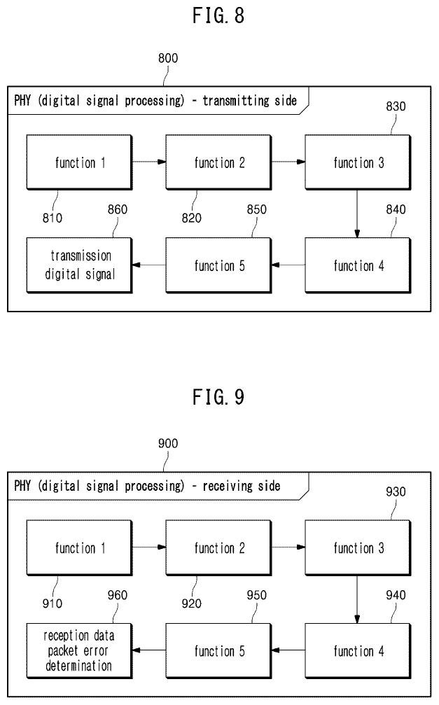

The training data of the AI model collected in the communication system may target situations in which the inference result is inaccurate. The situations in which the inference result is inaccurate may include a communication situation such as whether a packet error has occurred in the communication system. The communication system may collect various data related to communication situations. The performance degradation of the AI model may mean that methods applied when the AI model fails to perform normal operations are not operating properly. The cases in which the AI model fails to perform normal operations may include a case where the occurrence of communication errors increases. In the case of an AI model applied to a PHY layer, the base station or the terminal may indirectly check whether the inference result of the AI model is accurate through whether a packet error occurs. A method of determining whether an error occurs in the PHY layer of a transmitting side may be as shown in FIG. 8.

FIG. 8 is a block diagram illustrating exemplary embodiments of digital signal processing at a transmitting side.

Referring to FIG. 8, a transmitting side may perform various digital signal processing functions in the PHY layer. Function blocks may include at least one of a function 1 810, a function 2 820, a function 3 830, a function 4 840, a function 5 850, or a transmission digital signal block 860. At least one of the function 1 810, the function 2 820, the function 3 830, the function 4 840, or the function 5 850 may perform digital signal processing for data. In other words, the respective function blocks (functions 1 to 5) may perform a procedure for signal processing. The procedure for signal processing may include at least one of data modulation, channel coding, frame configuration, or multiplexing. The transmitting side may not be limited to the five function blocks described above. The transmission digital signal block 860 may transmit digitally processed data. A receiving side may receive the digitally processed data transmitted by the transmitting side. The receiving side may determine whether an error has occurred in the digitally processed data. A method of determining whether an error has occurred at the receiving side may be as shown in FIG. 9.

FIG. 9 is a block diagram illustrating exemplary embodiments of digital signal processing at a receiving side.

Referring to FIG. 9, a receiving side may perform various digital signal processing functions in the PHY layer. The receiving side may determine whether an error occurs in finally obtained data after performing digital signal processing functions. The receiving side may check whether an error has occurred in the data through a Cyclic Redundancy Check (CRC). When the receiving side determines that there is an error in the data, the receiving side may determine that there is a function block that has produced an inaccurate result among the digital signal processing functions applied to the PHY layer. The function blocks may include at least one of a function 1 910, a function 2 920, a function 3 930, a function 4 940, a function 5 950, or a reception data packet error determination block 960. At least one of the function 1 910, the function 2 920, the function 3 930, the function 4 940, or the function 5 950 may perform digital signal processing for data. In other words, the respective function blocks (i.e. functions 1 to 5) may perform a procedure for signal processing. The procedure for signal processing may include at least one of synchronization, decoding, demultiplexing, frame disassembly, demodulation, or data restoration. The receiving side may not be limited to the five function blocks described above. The reception data packet error determination block 960 may determine an error of the digitally processed data. The function blocks may be replaced with a single AI model. When replaced, the AI model may be represented as a single function block. In this case, an error identified through the CRC may indicate an inaccurate inference result of the AI model. If only some of the function blocks are replaced with an AI model, an error identified through the CRC may not directly indicate an inaccurate inference result of the AI model. Instead, it may suggest that the inference result of the AI model contributed to the occurrence of a packet error. When a packet error occurs, the base station or the terminal may store information and data related to the environment in which the packet error occurred.

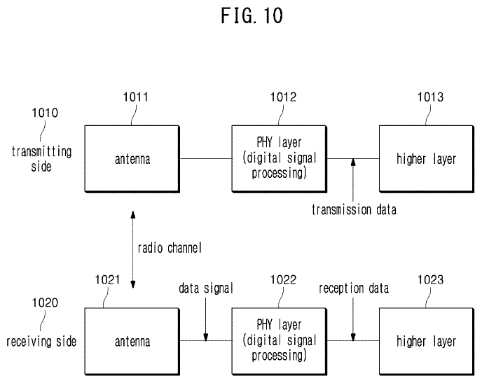

FIG. 10 is a block diagram illustrating exemplary embodiments of data transmission between a transmitting side and a receiving side.

Referring to FIG. 10, an AI model may receive input data that is input for retraining or supervised learning. The AI model may receive correct answer data that determine an accuracy of an inference value for retraining or supervised learning. The input data may include a digital signal input to the PHY layer of the receiving side. The correct answer data may include transmission data transmitted by the transmitting side. In other words, the correct answer data may refer to data input from a higher layer to the PHY layer at the transmitting side.

When a packet error occurs, the receiving side may store environment information related to a situation in which the packet error occurs. When a packet error occurs, the receiving side may store digital data corresponding to an input of the AI model. The digital data corresponding to the input of the AI model may refer to a digital signal. The transmitting side may store transmission data corresponding to the correct answer.

A transmitting side 1010 may include at least one of a higher layer 1013, a PHY layer 1012, or an antenna 1011. The higher layer 1013 may deliver transmission data to the PHY layer 1012. The PHY layer 1012 may receive the transmission data from the higher layer 1013. The PHY layer 1012 may perform a digital signal processing procedure on the transmission data. The PHY layer 1012 may deliver the digitally processed transmission data to the antenna 1011. The antenna 1011 may transmit the digitally processed transmission data to an antenna 1021 of a receiving side 1020. The antenna 1011 of the transmitting side 1010 and the antenna 1021 of the receiving side 1020 may transmit and receive data through a radio channel. The antenna 1021 of the receiving side may receive the digitally processed transmission data transmitted by the antenna of the transmitting side. The receiving side may include at least one of a higher layer 1023, a PHY layer 1022, or the antenna 1021. The antenna of the receiving side may deliver the digitally processed transmission data to the PHY layer 1022. The digitally processed transmission data may be referred to as a digital signal. The digitally processed transmission data may be referred to as input data. The PHY layer 1022 may perform a digital signal processing procedure on the digital signal. The PHY layer 1022 may generate reception data based on the digital signal. The PHY layer 1022 may deliver the reception data to the higher layer 1023.

In the communication system, the transmitting side and the receiving side may exist separately. The transmitting side and the receiving side may individually store data depending on the situation. The transmitting side and the receiving side may integrate the stored data.

When storing data, the transmitting side and the receiving side may construct training data for supervised learning of the AI model. The AI model may be trained using data having various correlations. The training data may be configured as various types of data that may be referenced for inference. The training data for the AI model utilized in the communication system may include data that may be helpful for training in relation to a functionality to which the AI model is applied. The AI model may require optimized training data for training depending on the model.

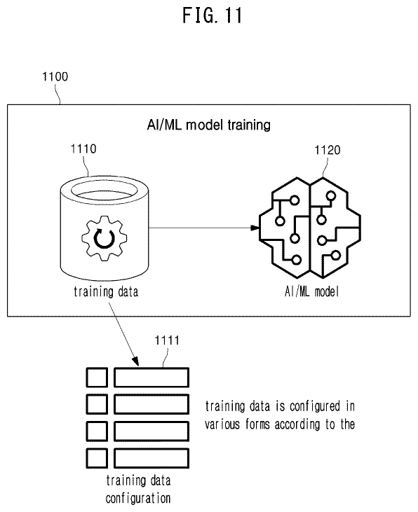

FIG. 11 is a conceptual diagram illustrating exemplary embodiments of AI/ML model training.

Referring to FIG. 11, training data 1110 and an AI/ML model 1120 may be required for AI/ML model training 1100. The training data 1110 may include data required for actual training. For each AI/ML model 1120, data required for actual training may include data collected in real time in the communication system. A final configuration of the training data for the AI/ML model 1120 may be configured by a developer of the AI model. The communication system may configure and store data that can be collected in real time. In other words, the base station or the terminal may collect real-time data. The real-time collected data may be referred to as collected data or training data 1110. A training data configuration 1111 may include the training data 1110. The training data configuration 1111 may appear in various forms depending on the AI model. Table 1 may represent a configuration of collected data for AI model training in the AI/ML field applied to the communication system.

TABLE 1

| Artificial | | | |
|---|---|---|---|
| Intelligence/ | | | |
| Machine Learn- | | | Iden- |
| ing (AI/ML) | | | tifi- |
| functionality | Collected data | | er |
| Physical (PHY) | Collected | Time, location information, | CD-1 |
| layer | at | speed, Signal to Noise | |
| functionality | receiving | Ratio (SNR), Reference | |
| | side | Signal Received Power | |
| | | (RSRP), Hybrid Automatic | |
| | | Repeat reQuest (HARQ) | |
| | | transmission informa- | |
| | | tion, received digital | |
| | | signal | |
| | Collected | Time, location informa- | CD-2 |
| | at trans- | tion, speed, transmission | |
| | mitting | power, transmitting | |
| | side | data | |

| Handover | Time, location information, speed, | CD-3 |
|---|---|---|
| | serving cell RSRP and/or SNR, neighbor | |
| | cell RSRP and/or SNR, packet errors | |
| | occurring during handover procedure | |
| | (collection of data when PHY | |
| | errors occur) | |
| Radio link | Time, location information, speed, | CD-4 |
| failure (RLF) | SNR, RSRP | |
| determination | | |
| Dynamic beam | Time, per-beam slot allocation, per-beam | CD-5 |
| hopping | traffic configuration, per-beam traffic | |
| scheduling | demand, per-beam combined power, per-beam | |
| | channel status, scheduling cycle unit, | |
| | per-beam uplink/downlink throughput | |
| . . . | . . . | . . . |

The collected data in Table 1 may be configured with data that can be collected in the communication system depending on an applied field in addition to the defined AI/ML field. Identifiers in Table 1 may refer to identifiers used for distinguishing sets of collected data defined within the communication system. PHY functionality data in Table 1 may include a received digital signal of the receiving side. The PHY functionality data in Table 1 may include the transmission data of the transmitting side. The receiving side may not collect the digital signal as needed. The transmitting side may not collect the transmission data as needed. The receiving side and the transmitting side may collect related situation data.

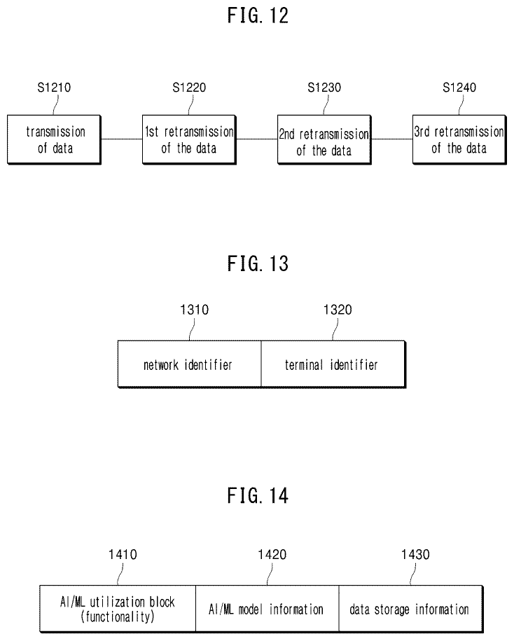

The configuration of collected data in Table 1 may include HARQ transmission information. The HARQ transmission information may refer to information to reflect characteristics of HARQ operations. The HARQ operation may provide additional coding gain by transmitting a packet containing different additional information rather than retransmitting the same packet when a packet error occurs. An HARQ retransmission may be performed as shown in FIG. 12.

FIG. 12 is a flowchart illustrating exemplary embodiments of a HARQ retransmission form.

Referring to FIG. 12, the base station or the terminal may transmit data (S1210). The base station or the terminal may perform HARQ procedures. The HARQ procedures may include a procedure in which the base station or the terminal retransmits the data. In other words, the base station or the terminal may perform a first retransmission of the data (S1220). The base station or the terminal may perform a second retransmission of the data (S1230). The base station or the terminal may perform a third retransmission of the data (S1240). The base station or the terminal may retransmit data up to a maximum of three times. The terminal may collect HARQ transmission information. The HARQ transmission information may include information on a current HARQ status. In other words, when a packet error occurs in a state where HARQ is configured to be used, information including the current HARQ status (e.g. HARQ transmission information) may be accurate information on a current status. In other words, data including information on the number of HARQ retransmissions may indicate that the data is accurate information on the current status. Information on the number of HARQ retransmissions may refer to data retransmission count information.

Referring again to Table 1, the data in Table 1 may be stored when a defined type of event occurs during communication, rather than being always stored by the transmitting side or the receiving side. It may be important to obtain actual data on a situation in which the performance of the AI/ML model is degraded. It may be important to obtain actual data of interest (e.g. a situation of high importance) of the AI/ML model. In order to obtain actual data for the AI/ML model, the transmitting side and/or the receiving side may separately define events requiring to be stored. Configuration information of events requiring to be stored may be represented as shown in Table 2.

TABLE 2

| Event | Trigger condition | Identifier |
|---|---|---|
| Packet error | Error detection through CRC | E-1 |
| | (cyclic redundancy check) | |
| Packet error | Error detection through feedback | E-2 |
| | information | |
| Handover | First handover failure threshold | E-3 |
| RLF (Radio Link Failure) | First RLF failure threshold | E-4 |
| Dynamic beam hopping | Beam hopping scheduling | E-5 |
| | execution | |
| . . . | . . . | . . . |

Table 2 may represent an example of event configuration information. The configuration of collected data in Table 1 and the event configuration in Table 2 may correspond to each other. In other words, when a specific event in Table 2 occurs, the transmitting side and/or the receiving side may store a specific collected data configuration of Table 1. The configurations of Table 1 and Table 2 may be exemplary. The configurations of Table 1 and Table 2 may be further subdivided depending on actual collected data configurations and event types. When specifications of terminals are diverse, the subdivided configurations may include a collected data configuration classified by class. When specifications of terminals are diverse, a terminal may use a subdivided configuration according to a performance of the terminal. When specifications of terminals are diverse, the subdivided configurations may include defined target events classified by class. When specifications of terminals are diverse, target events may be applied according to a performance of the terminal.

The transmitting side and/or the receiving side may ultimately combine stored data according to a collected data configuration for each event. The transmitting side and/or the receiving side may require an identifier that can confirm that collected data was collected for the same communication link in order to ultimately combine the stored data. The communication system may have unique identifiers that can distinguish terminals and subscribers for reasons such as billing. The transmitting side and/or the receiving side may utilize an identifier that is randomly assigned at a time of establishing a communication connection in order to maintain anonymity when collecting data for AI model training. The identifier may be assigned by the base station at an initial connection. The transmitting side and/or the receiving side may terminate communication at another base station using the identifier. The transmitting side and/or the receiving side may upload stored data through a network using the identifier. The identifier randomly assigned by the base station may be represented as shown in FIG. 13 in order to prevent a collision within the network.

FIG. 13 is a block diagram illustrating exemplary embodiments of an identifier for data storage.

Referring to FIG. 13, an identifier for data storage may be referred to as a data storage identifier. The identifier randomly assigned by the base station may include at least one of a network identifier 1310 or a terminal identifier 1320. The transmitting side and/or the receiving side may distinguish an identifier assigned by a specific base station. The transmitting side and/or the receiving side may distinguish an identifier assigned by a specific base station and combine data of the receiving side and the transmitting side. Sizes of a portion corresponding to the network identifier 1310 and a portion corresponding to the terminal identifier 1320 may be determined considering a configuration of the communication system. For example, when the network identifier is configured as 16 bits and the terminal identifier is configured as 16 bits, the network and the terminal may be distinguished as up to 65536 each. The transmitting side and/or the receiving side may perform a procedure of ultimately combining stored data using the data storage identifier. The data combining procedure may refer to a procedure in which the transmitting side and/or the receiving side ultimately combines stored data using the data storage identifier. The data combining procedure may be performed in a place such as a Mobile Edge Computing (MEC) server. Data combined by the data combining procedure may be managed as data for retraining the AI model.

When starting communication, the terminal may store data reflecting collected data, events, or identifiers. In order to store data reflecting collected data, events, or identifiers, the terminal may transmit AI/ML related information to an initial base station when accessing the initial base station. The AI/ML related information may be represented as shown in FIG. 14.

FIG. 14 is a block diagram illustrating exemplary embodiments of AI/ML related information.

Referring to FIG. 14, the AI/ML related information may include at least one of an AI/ML utilization block (functionality) 1410, AI/ML model information 1420, or data storage information 1430. The AI/ML utilization block 1410 may include information for utilizing AI/ML functionality in the terminal. In other words, the AI/ML utilization block 1410 may include information on AI/ML functionalities utilized in the terminal. The AI/ML model information 1420 may include information on models used for AI/ML functionalities. The AI/ML model information 1420 may be used for management at the AI mode level. When not managed at the AI model level, the AI/ML model information 1420 may be omitted. The data storage information 1430 may include information related to a capability of the terminal to store data for retraining. The data storage information 1430 may include at least one of a number of simultaneous events, event types, collected data configurations, or a maximum storage size supported by the terminal. The AI/ML related information may be directly configured and transmitted with individual values. The AI/ML related information may be transmitted to the terminal by classifying class information based on general capabilities of terminals. In other words, the AI/MVL related information may be mapped to the data storage identifier based on general capabilities of terminals. The terminal may receive an identifier mapped to general capabilities of terminals. The AI/MVL, functions and identifiers for AI/ML functions may be represented as shown in Table 3.

TABLE 3

| | AI/ML (Artificial Intelligence/ |
|---|---|
| Identifier | Machine Learning) functionalities |
| F-1 | PHY (Physical Layer) transmission |
| F-2 | PHY reception |
| F-3 | Handover |
| F-4 | Not used |
| . . . | . . . |

The AI/ML functionality information may be transmitted to the terminal through an identifier. The AI/MVL, model information and an identifier for the AI/ML model information may be represented as shown in Table 4.

TABLE 4

| | AI/ML (Artificial Intelligence/ |
|---|---|
| Identifier | Machine Learning) models |
| M-1 | Model Name Version |
| M-2 | NULL |
| M-3 | . . . |
| . . . | . . . |

The AI/ML model information may be transmitted to the terminal through an identifier. The data storage information and an identifier for the data storage information may be represented as shown in Table 5.

TABLE 5

| Identifier | Data storage class |
|---|---|
| S-1 | Number of simultaneous storable events n, |
| | maximum storage space S-1 Mbytes, supported |
| | event types, supported collected data |
| | configurations |
| S-2 | NULL |
| . . . | . . . |

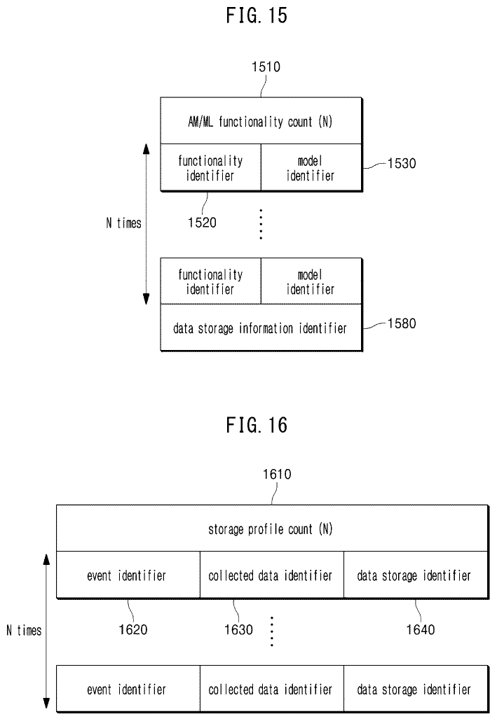

The data storage information may be transmitted to the terminal through an identifier. The AI/ML related information may include at least one of the information in Table 3, Table 4, or Table 5. When the terminal uses multiple AI/ML functionalities, the AI/ML related information may be represented as shown in FIG. 15.

FIG. 15 is a block diagram illustrating exemplary embodiments of an AI/ML information provision message.

Referring to FIG. 15, the terminal may transmit an AI/ML information provision message to the base station. In other words, the terminal may transmit AI/ML related information to the base station in the form of the AI/ML information provision message. The configuration of the AI/ML related information may vary depending on whether all AI/IL related functionalities are managed by the communication system. The AI/ML information provision message may include at least one of an AI/ML functionality count N 1510, a function identifier 1520, a model identifier 1530, or a data storage information identifier 1580. The AI/ML functionality count N 1510 may indicate the number of functionalities of AI models included in the terminal or the base station. The functionality identifier 1520 may indicate an identifier for distinguishing an functionality of AI model(s) included in the terminal or the base station. The model identifier 1530 may indicate an identifier for distinguishing an AI model included in the terminal or the base station. The data storage information identifier 1580 may indicate an identifier for distinguishing information related to a data storage capability of the terminal or the base station. The AI/ML information provision message may include the functionality identifier 1520 or the model identifier 1530 in a number equal to the AI/ML functionality count 1510 (e.g. N times). The data storage information identifier 1580 may include an identifier for information related to a storage capability of the terminal or the base station transmitting the AI/ML information provision message.

When the communication system manages AI/ML related functionalities of terminals using AI/ML functionalities as a whole, the terminals may transmit only information such as a terminal class defined in the communication system to the base station. When the communication system manages AI/ML related functionalities of terminals using AI/ML functionalities as a whole, the base station may recognize AI/ML related information based only on information such as the terminal class transmitted by the terminal. The terminal may transmit information defining the terminal class to the base station. Since the data storage information may vary depending on hardware and software specifications of each terminal manufacturer, the data storage information may be transmitted separately.

A terminal not using AI/ML functionalities may transmit AI/ML related information to the base station. Even when the terminal does not use AI/ML functionalities, the base station may require data related to AI/ML functionalities provided by the base station. Even when the terminal does not use AI/ML functionalities, the base station may request data collection from the terminal.

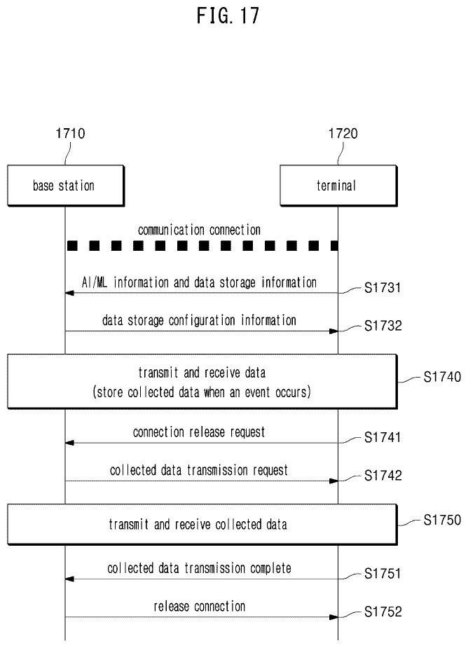

The base station may receive the AI/ML related information transmitted by the terminal. The base station may determine a profile for storing data for retraining of the AI model using the AI/ML related information. The profile may include information related to data collection for event(s). The base station may transmit the profile to the terminal. The base station may transmit profile information to the terminal. The profile information may include at least one of event identifier(s), collected data identifier(s), or data storage identifier(s). When data collection for multiple events is required, the base station may transmit data collection related information as shown in FIG. 16 to the terminal.

FIG. 16 is a block diagram illustrating exemplary embodiments of data collection information for multiple events.

Referring to FIG. 16, data collection information may be referred to as data storage configuration information. The data collection information may include at least one of a storage profile count 1610, an event identifier 1620, a collected data identifier 1630, or a data storage identifier 1640. Each storage profile may include at least one of an event identifier 1620, a collected data identifier 1630, or a data storage identifier 1640. The data collection information may include N storage profiles. The base station and the terminal may store data for AI/ML model retraining while performing communication. A procedure for storing data for AI/ML model retraining may be as shown in FIG. 17.

FIG. 17 is a sequence chart illustrating exemplary embodiments of transmission of collected data.

Referring to FIG. 17, when a terminal 1720 transmits a connection release request to a base station 1710, the base station 1710 and the terminal 1720 may transmit collected data. In other words, when a communication connection is terminated, the base station 1710 and the terminal 1720 may transmit collected data. The terminal 1720 may transmit data stored during communication to the base station 1710 along with the termination of the communication.

The base station 1710 and the terminal 1720 may be connected for communication. The terminal 1720 may transmit AI/ML related information to the base station 1710. The AI/ML related information may include AI/ML information or data storage information. In other words, the terminal 1720 may transmit AI/ML information to the base station 1710 (S1731). The AI/ML information may include at least one of an AI/ML utilization block or AI/ML model information. The terminal 1720 may transmit information related to storage capability to the base station 1710. The terminal 1720 may transmit an AI/ML information provision message to the base station 1710. The base station 1710 may receive the AI/ML information transmitted by the terminal 1720. The base station 1710 may receive the storage capability information transmitted by the terminal 1720.

The base station 1710 may generate data storage configuration information based on the information transmitted by the terminal 1720. In other words, the base station 1710 may generate data collection information based on the information transmitted by the terminal 1720. The data collection information may include at least one of configuration information of collected data or event configuration information. The base station 1710 may transmit data storage configuration information to the terminal 1720 that the terminal 1720 should perform (S1732). The terminal 1720 may receive the data storage configuration information transmitted by the base station 1710.

The terminal 1720 and the base station 1710 may transmit and receive data while performing communication (S1740). The terminal 1720 may be referred to as a receiving side. The base station 1710 may be referred to as a transmitting side. In other words, the transmitting side and the receiving side may transmit data. When a defined event occurs, the terminal 1720 and the base station 1710 may store collected data. The base station 1710 and the terminal 1720 may store collected data using a data storage identifier when storing the collected data. The stored collected data may be referred to as stored data.

When the terminal 1720 intends to terminate communication with the base station, the terminal 1720 may transmit a connection release request to the base station (S1741). The base station may receive the connection release request transmitted by the terminal 1720.

The base station 1710 may transmit a stored data transmission request (or collected data transmission request) to the terminal 1720 (S1742). The terminal 1720 may receive the stored data transmission request transmitted by the base station 1710. The terminal 1720 and the base station 1710 may transmit and receive collected data (S1750).

The terminal 1720 may transmit the stored data to the base station 1710 (S1751). The base station 1710 may receive the stored data transmitted by the terminal 1720.

When transmission of the stored data is completed, the base station 1710 may transmit a communication connection release to the terminal 1720 (S1752). The terminal 1720 may receive the communication connection release transmitted by the base station 1710.

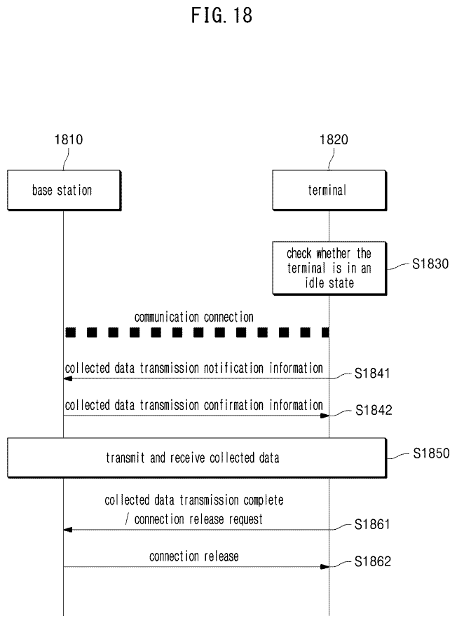

The terminal 1720 may transmit the stored data during a time when the terminal 1720 is not in use. A procedure for transmitting the stored data during a time when the terminal 1720 is not in use may be represented as shown in FIG. 18.

FIG. 18 is a sequence chart illustrating exemplary embodiments of transmission of collected data.

Referring to FIG. 18, a case where a terminal 1820 is not in use may include, for example, a case where the terminal 1820 performs a Over The Air (OTA) update, or a case of an early morning period when usage of the terminal 1820 is very low.

The terminal 1820 may check whether it is in an idle state (S1830). The idle state may include a state of the terminal 1820 during a nighttime period. The terminal 1820 may perform communication connection with a base station 1810. When the terminal 1820 is connected to the base station 1810, the terminal 1820 may transmit stored data transmission notification information (or collected data transmission notification information) to the base station 1810 (S1841). The stored data transmission notification information may include information notifying the base station 1810 that the terminal 1820 is to perform transmission of stored data. The base station 1810 may receive the stored data transmission notification information transmitted by the terminal 1820. The base station 1810 may transmit stored data transmission confirmation information (or collected data transmission confirmation information) to the terminal 1820 (S1842). The stored data transmission confirmation information may include information confirming that transmission of the collected data stored by the terminal 1820 is to be started. The terminal 1820 may receive the stored data transmission confirmation information transmitted by the base station 1810. The base station 1810 and the terminal 1820 may transmit and receive collected data (S1850). In other words, the terminal 1820 may transmit the stored collected data (e.g. stored data) to the base station 1810. The base station 1810 may receive the collected data transmitted by the terminal 1820. When transmission of the collected data is completed, the terminal 1820 may notify the base station 1810 that the transmission of the collected data has been completed. In other words, the terminal 1820 may transmit a collected data transmission completion message to the base station 1810 (S1861). When transmission of the collected data is completed, the terminal 1820 may transmit a connection release request message to the base station 1810. The base station 1810 may receive the connection release request message transmitted by the terminal 1820. The base station 1810 may terminate communication connection with the terminal 1820 based on the connection release request message transmitted by the terminal 1820. The base station 1810 may transmit a connection release message to the terminal 1820 (S1862). The connection release message may include information confirming the communication connection release to the terminal 1820 from the base station 1810.

The collected data received by the base station 1810 may be transmitted to an entity defined in the communication system as being related to data storage. In other words, the base station 1810 may transmit the collected data transmitted by the terminal 1820 and the collected data of the base station 1810 to a data storage entity. For example, when an MEC server performs a function related to data storage in the communication system, the base station 1810 may transmit the collected data to the MEC server. The collected data of the terminal 1820 may be transmitted to the base station 1810 and then transmitted to the MEC server. When communication with the terminal 1820 is terminated, the collected data of the base station 1810 may be transmitted to the entity responsible for data storage (e.g. MEC). The entity responsible for data storage may be referred to as a data storage.

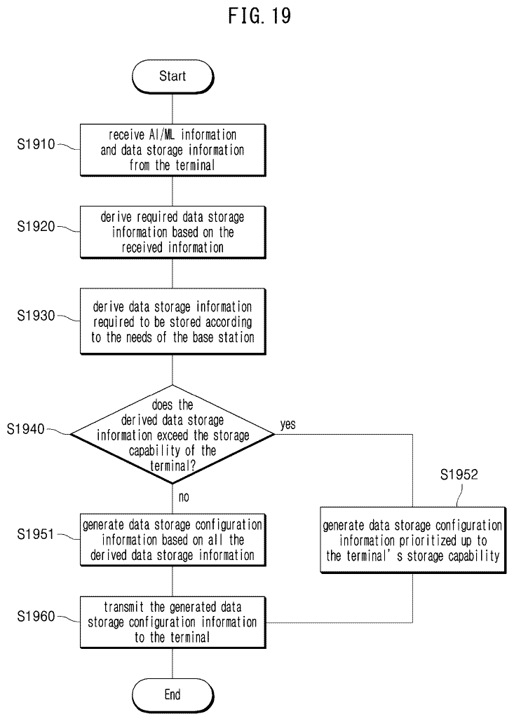

A procedure in which the base station generates data storage configuration information using AI/ML information or data storage information may be represented as shown in FIG. 19.

FIG. 19 is a flowchart illustrating exemplary embodiments of data storage configuration information.

Referring to FIG. 19, the base station may receive at least one of AI/ML information or data storage information received from the terminal (S1910). The data storage information may include information on a data storage capability of the terminal. The base station may derive required data storage information based on the received information (S1920). In other words, the base station may extract data storage information required for the terminal to store training data based on the received information. The data storage information may include collected data configuration or event information. The base station may extract data storage information that needs to be stored according to the needs of the base station (S1930). In other words, the base station may derive data storage information for training data of the base station that needs to be stored according to the needs of the base station. The data storage information may include collected data configuration or event information required for operation of the base station.

The base station may determine whether the extracted data storage information exceeds the storage capability of the terminal (S1940). In other words, the base station may determine whether the collected data configuration or event extracted by the base station can be supported with the storage capability of the terminal transmitted by the terminal.

When the extracted data storage information exceeds the storage capability of the terminal, the base station may generate data storage configuration information to a level that can be stored by the terminal according to priority (S1952). In other words, when the terminal cannot support the extracted event and collected data configuration information, the base station may reconfigure the data storage information according to priority. The base station may generate data storage configuration information using the reconfigured data storage information according to priority. In other words, the base station may generate the data storage configuration information considering the storage capability of the terminal.

When the extracted data storage information does not exceed the storage capability of the terminal, the base station may generate data storage configuration information using all the derived data (S1951). The base station may transmit the data storage configuration information to the terminal (S1960).

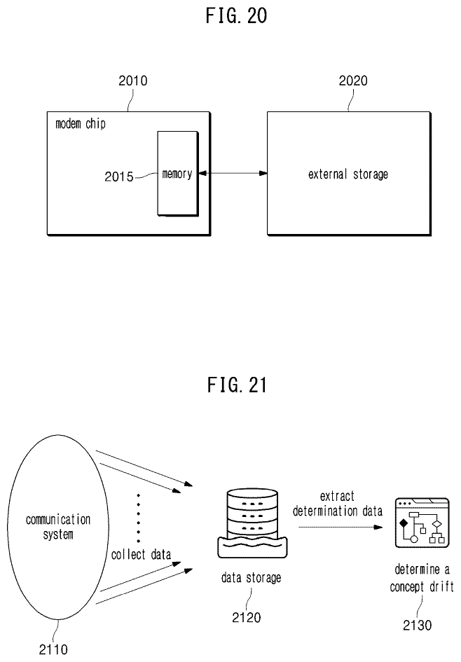

FIG. 20 is a conceptual diagram illustrating exemplary embodiments of collected data storage.

Referring to FIG. 20, the terminal or the base station may store collected data in a memory 2015 included in a modem chip 2010. When the amount of collected data to be stored is large, the terminal may store the collected data in an external storage 2020. When the amount of collected data to be stored is large, the base station may store the collected data in an external storage 2020. When the amount of collected data of the terminal or the collected data of the base station is large, the base station may store the collected data in an external storage 2020. The collected data stored in the external storage 2020 may include data requested by the base station.

FIG. 21 is a conceptual diagram illustrating exemplary embodiments of concept drift determination.

Referring to FIG. 21, a communication system 2110 may be operated in a form that manages both AI/ML functionalities and AI/ML models utilized internally. The communication system 2110 may include a base station or a terminal. The base station or the terminal may collect data and store the collected data in a data storage 2120. The collected data may include data collected for AI model retraining. The data storage 2120 may extract determination data from the collected data and transmit the determination data to the base station or the terminal. The base station or the terminal may detect occurrence of a concept drift in the AI model based on the determination data 2130. The determination data may include data extracted from the collected data by the data storage 2120. The terminal or the base station may monitor the AI/ML functionalities in real time. The terminal or the base station may detect a concept drift. Real-time monitoring of AI/ML functionalities may impose additional load on the terminal or the base station. Real-time detection of a concept drift for AI/ML functionalities may impose additional load on the terminal or the base station. The terminal or the base station may detect a concept drift using stored collected data to reduce additional load. The terminal or the base station may detect a concept drift based on data collected from a plurality of entities (e.g. a plurality of terminals or a plurality of base stations). Detecting a concept drift based on the data collected from the plurality of entities may be more accurate.

When determining a concept drift, the terminal or the base station may extract data from the data storage 2120 and use the data. When the terminal or the base station extracts the data, the terminal or the base station may extract the data based on at least one of an AI/ML functionality, an AI/ML model, or an event. When it is determined that a concept drift has occurred, the AI/ML model may be retrained. When it is determined that a concept drift has occurred, the AI/ML model may be updated. When the update of the AI/ML model is completed, the AI/ML model may perform a function update process through the communication system. Among the AI/ML models, a portion related to functions of the base station may undergo a function update procedure through a communication equipment system. Among the AI/ML models, a portion related to functions of the terminal may undergo an update procedure in an OTA form.

The present disclosure may be used not only for AI model retraining using collected data but also when developing a new model. Utilization of collected data may not be limited to the AI model retraining.

The operations of the method according to the exemplary embodiment of the present disclosure can be implemented as a computer readable program or code in a computer readable recording medium. The computer readable recording medium may include all kinds of recording apparatus for storing data which can be read by a computer system. Furthermore, the computer readable recording medium may store and execute programs or codes which can be distributed in computer systems connected through a network and read through computers in a distributed manner.

The computer readable recording medium may include a hardware apparatus which is specifically configured to store and execute a program command, such as a ROM, RAM or flash memory. The program command may include not only machine language codes created by a compiler, but also high-level language codes which can be executed by a computer using an interpreter.

Although some aspects of the present disclosure have been described in the context of the apparatus, the aspects may indicate the corresponding descriptions according to the method, and the blocks or apparatus may correspond to the steps of the method or the features of the steps. Similarly, the aspects described in the context of the method may be expressed as the features of the corresponding blocks or items or the corresponding apparatus. Some or all of the steps of the method may be executed by (or using) a hardware apparatus such as a microprocessor, a programmable computer or an electronic circuit. In some embodiments, one or more of the most important steps of the method may be executed by such an apparatus.

In some exemplary embodiments, a programmable logic device such as a field-programmable gate array may be used to perform some or all of functions of the methods described herein. In some exemplary embodiments, the field-programmable gate array may be operated with a microprocessor to perform one of the methods described herein. In general, the methods are preferably performed by a certain hardware device.

The description of the disclosure is merely exemplary in nature and, thus, variations that do not depart from the substance of the disclosure are intended to be within the scope of the disclosure. Such variations are not to be regarded as a departure from the spirit and scope of the disclosure. Thus, it will be understood by those of ordinary skill in the art that various changes in form and details may be made without departing from the spirit and scope as defined by the following claims.

What is claimed is:

1. A method of a terminal, comprising:
transmitting, to a base station, at least one of Artificial Intelligence/Machine Learning (AI/ML) information of the terminal or data storage information which is a data storage capability of the terminal;
receiving data storage configuration information generated by the base station based on the data storage information;
storing collected data for event(s) included in the data storage configuration information; and
transmitting and receiving the collected data with the base station.

2. The method according to claim 1, wherein the transmitting and receiving of the collected data comprises:
transmitting a connection release request to the base station;
in response to the connection release request, receiving a collected data request from the base station; and
transmitting and receiving the collected data with the base station.

3. The method according to claim 1, wherein the transmitting and receiving of the collected data comprises:
identifying an idle state of the terminal;
transmitting collected data transmission notification information to the base station in the idle state;
receiving collected data transmission confirmation information from the base station; and
transmitting and receiving the collected data with the base station based on the collected data transmission confirmation information.

4. The method according to claim 1, further comprising:
combining the collected data to generate training data; and
retraining an AI model included in the terminal using the training data.

5. The method according to claim 1, wherein the transmitting of the at least one of the AI/ML information or the data storage information comprises: transmitting, to the base station, a message including at least one of: AI/ML functionality identifier(s) for AI/ML functionalities included in the AI/ML information of the terminal, AI/ML model information identifier(s) for AI/ML model(s) included in the AI/ML information, or a data storage information identifier for the data storage information.

6. The method according to claim 1, wherein in the transmitting and receiving of the collected data, the collected data includes at least one identifier among a network identifier for the terminal and the base station or a terminal identifier of the terminal.

7. A method of a base station, comprising:
receiving, from a terminal, at least one of Artificial Intelligence/Machine Learning (AM/ML) information or data storage information;
generating data storage configuration information using at least one of the AI/ML information or the data storage information;
transmitting the data storage configuration information to the terminal;
storing second collected data for event(s) included in the data storage configuration information; and
receiving first collected data collected by the terminal using the data storage configuration information.

8. The method according to claim 7, further comprising:
transmitting the first collected data and the second collected data to a data storage;
determining whether a concept drift occurs for an AI/ML model using data in the data storage; and
in response to determining that a concept drift occurs, retraining the AI/ML model using the data as training data.

9. The method according to claim 7, wherein the generating of the data storage configuration information comprises:
determining a priority of the collected data by using storage capacity information of the terminal included in the data storage information; and
generating the data storage configuration information according to the priority.

10. The method according to claim 8, wherein the determining of whether a concept drift occurs for the AI/ML model comprises:
extracting data for each AI/ML functionality or each AI/ML model stored in the data; and
determining whether a concept drift occurs for each AI/ML functionality or each AI/ML model based on the extracted data.

11. The method according to claim 7, wherein the data storage configuration information includes at least one of an event identifier for the terminal to collect data, a collected data identifier that is a type of data collected by the terminal, or a data storage identifier for identifying when storing the collected data.

12. A terminal comprising at least one processor, wherein the at least one processor causes the terminal to perform:
transmitting, to a base station, at least one of Artificial Intelligence/Machine Learning (AI/ML) information of the terminal or data storage information which is a data storage capability of the terminal;
receiving data storage configuration information generated by the base station based on the data storage information;
storing collected data for event(s) included in the data storage configuration information; and
transmitting and receiving the collected data with the base station.

13. The terminal according to claim 12, wherein in the transmitting and receiving of the collected data, the at least one processor further causes the terminal to perform:
transmitting a connection release request to the base station;
in response to the connection release request, receiving a collected data request from the base station; and
transmitting and receiving the collected data with the base station.

14. The terminal according to claim 12, wherein in the transmitting and receiving of the collected data, the at least one processor further causes the terminal to perform:
identifying an idle state of the terminal;
transmitting collected data transmission notification information to the base station in the idle state;
receiving collected data transmission confirmation information from the base station; and
transmitting and receiving the collected data with the base station based on the collected data transmission confirmation information.

15. The terminal according to claim 12, wherein the at least one processor further causes the terminal to perform:
combining the collected data to generate training data; and
retraining an AI model included in the terminal using the training data.

16. The terminal according to claim 12, wherein in the transmitting of the at least one of the AI/ML information or the data storage information, the at least one processor further causes the terminal to perform: transmitting, to the base station, a message including at least one of: AI/ML functionality identifier(s) for AI/ML functionalities included in the AI/ML information of the terminal, AI/ML model information identifier(s) for AI/ML model(s) included in the AI/ML information, or a data storage information identifier for the data storage information.

17. The terminal according to claim 12, wherein in the transmitting and receiving of the collected data, the collected data includes at least one identifier among a network identifier for the terminal and the base station or a terminal identifier of the terminal.
